(19) United States
(12) Patent Application Publication
(10) Pub. No.: US 2006/0124364 A1
(43) Pub. Date: Jun. 15, 2006

(54) Method for monitoring a weight-sensing system

(75) Inventors: Klaus-Dieter Loewen, Balingen (DE); Mark Provoznik, Hemmingen (DE); Harald Rudolf, Tuebingen (DE); Karl Schweizer, Radolfzell (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChryser AG, Stuttgart (DE)

(21) Appl. No.: 10/532,487

(22) PCT Filed: Oct. 7, 2003
(86) PCT No.: PCT/EP03/11048

§ 371 Date: Apr. 22, 2005

(30) Foreign Application Priority Data
Oct. 24, 2002 (DE) 10249440.1

(51) Int. Cl. B60R 21/16; G01G 23/18; E05F 15/00; G01G 23/01

(52) U.S. Cl. 177/45; 701/45; 180/273; 280/735; 73/1.13

(57) ABSTRACT

In the case of a process for monitoring the operability of a weight-sensing system in a vehicle with at least one force sensor (2, 4, 6, 8), the weight-sensing system emits a warning message when a threshold value for the force acting upon the force sensor (2, 4, 6, 8) is exceeded, which warning message points to a possible damage to the weight-sensing system. This measure ensures a reliable detection of a possible failure of the weight-sensing system.

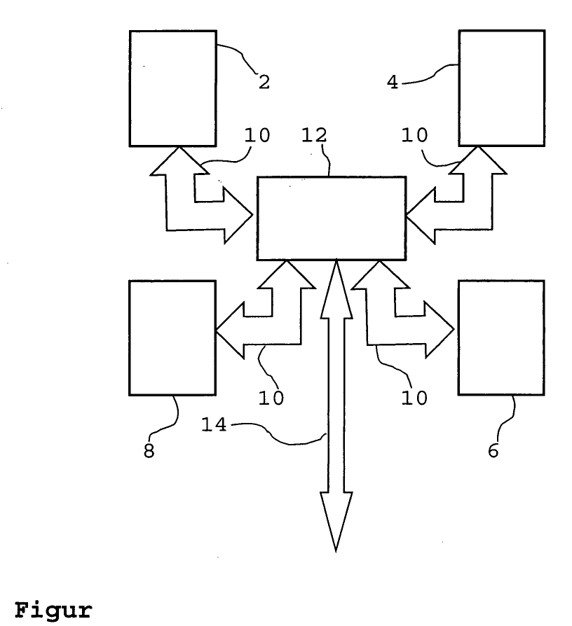

This application claims priority to International Patent Application No. PCT/EP03/011048, filed Oct. 7, 2003, designating the United States of America, and German Application DE 102 49 440.1 filed on Oct. 24, 2002, the entire disclosure of which is incorporated herein by reference.

### BACKGROUND AND SUMMARY OF THE INVENTION

The invention relates to a method of monitoring the operatability of a weight-sensing system in a vehicle with at least one force sensor.

A trend has developed in recent years for controlling occupant protection systems in vehicles, particularly vehicle seat belts and air bags, by which the triggering characteristic of such safety devices is adapted to the occupant's weight by using a sitting weight measuring device as a weight-sensing system. Currently, force-sensitive foils are used in the seat area in vehicles of the applicant, which foils allow an approximate estimate of the occupant's body weight by way of the occupant's weight distribution.

The vehicle seat normally comprises seat rails, seat frames, a seat bucket and an adjusting mechanism. Since the occupants' load is transmitted to a vehicle chassis by the side frames and the seat rails, the side frames and the seat rails are subjected to the occupants' weight. Force sensors are therefore used for measuring the total weight of the vehicle seat. The force sensors are positioned at the upper or lower surfaces of the seat rails or sections of the side frames.

An occupant weight sensor therefore should have precise detection as well as stability. For example, a strain gauge force transducer and an inductive force sensor are known from German Patent Document DE 44 20 691 C1. The strain gauge transduces the surface elongation of an elastic body generated by the force to be measured into an ohmic resistance change of strain gauges which are then processed by the signal processing of the balance. In the case of the inductive force sensor, a weight acting upon a measuring cell generates an elongation of a ferromagnetic tension rod enveloped by means of a coil. In this case, the inductivity of the coil is reduced which results in an increase of the frequency of an oscillator connected on the output side. A conclusion is drawn with respect to the weight from the frequency change.

As a result of a strong shock or in the event of an impact, a so-called crash, the weight-sensing system may be detuned by the acting forces, for example, by shearing forces such that a new adjusting or calibration of the entire weight-sensing system is required. The operatability of the weight-sensing system is important for the functioning of the occupant protection systems and thus for the occupants' safety.

It is now an object of the invention to provide a method of monitoring the operatability of a weight-sensing system in the vehicle which ensures a reliable detection of a possible failure of the weight-sensing system.

According to the invention, the weight-sensing system emits a warning message when a defined value—a threshold value—for the force acting upon a force sensor is exceeded, which warning message indicates a possible damage to the weight-sensing system. In the event of strong shocks caused, for example, by an extreme pothole in the road surface, or in the event of an impact, high forces act upon the force sensor and thus upon the weight-sensing system, which may result in a failure of the weight-sensing system. The defined value for the force acting upon the force sensor is therefore selected such that its magnitude corresponds to the values which occur in the event of violent shocks. The occupants of the vehicle are informed in time concerning a possible failure of the weight-sensing system and, for checking the weight-sensing system, can immediately take the vehicle to a repair shop since a failure of the weight-sensing system can also lead to functional disturbances in the operation of the occupant protection system. This improves the occupant protection.

In a further development, in the event of an impact of the motor vehicle, the warning message is emitted by an impact sensor of the vehicle which senses the impact and which is not the weight-sensing system. The reliability of the detection of a possible failure of the weight-sensing system is thereby further increased and designed to be independent of the weight-sensing system itself. Particularly when the defined value for the force acting upon the force sensor of the weight-sensing system in the event of an impact of the vehicle is not reached, the warning message can be emitted by an occupant protection system sensing the impact.

Other objects, advantages and novel features of the present invention will become apparent from the following detailed description of the invention when considered in conjunction with the accompanying drawings.

### BRIEF DESCRIPTION OF THE DRAWINGS

The sole FIGURE shows a block diagram of the system description for a method of monitoring the operatability of a weight-sensing system in a vehicle.

### DETAILED DESCRIPTION OF THE DRAWINGS

According to the FIGURE, the block diagram of a weight-sensing system of a four-seat vehicle comprises force sensors 2, 4, 6, 8 which are arranged in the vehicle corresponding to the distribution of the front and rear seats. As a rule, the weight-sensing system has a number of force sensors 2, 4, 6, 8 corresponding to the number of seats. Strain gauge force transducers, inductive sensors and/or piezoelectric sensors can be provided as the force sensors 2, 4, 6, 8. However, other sensors are also suitable for use in the weight-sensing system. The force sensors 2, 4, 6, 8 each include an amplifier with a signal filter as well as an analog-to-digital converter. The detected measured values are temperature-compensated and transmitted by way of three-wire lines 10 to a control unit 12 of the weight-sensing system. The three-wire lines 10 permit a grounding, a power supply of the force sensors 2, 4, 6, 8 and a bidirectional data exchange with the force sensors 2, 4, 6, 8.

All occupant-related weights are detected by means of the force sensors 2, 4, 6, 8. In addition, the position of the mass center of gravity is determined for each seat. In addition to the weights acting upon the seat bucket, the weights acting upon the seat backrest are also taken into account. Further, additionally acting forces which cannot be assigned to an occupant's weight are corrected in the control unit 10 in order to be able to determine the occupants' weight as precisely as possible. For example, a force diversion by way of the legs is corrected by taking into account the mass center of gravity. Jammed-in objects under the seat, which falsify the actual weight, can be compensated by way of suitable covering measures or intelligent algorithms. Occurring lateral forces can be compensated by the further development of the force sensors 2, 4, 6, 8 or by a more suitable application. Undesirable forces caused by vibrations during the driving operation on a rough route are filtered out.

A precise weight sensing of the occupants is required for an individual person-related controlling of the occupant protection system. A resolution in the kilogram range is required in order to be able to differentiate between defined weight classes with different triggering conditions. For, example, at a weight lower than 35 kg, a safety air bag should not be triggered. This weight class may involve a child or a child with a child seat. In this weight class, a triggered air bag may lead to injuries in a wrong sitting position. At a weight of over 40 kg—the weight of a light adult—, a triggering will, in turn, be necessary. The inflating pressure of the air bags as well as the contact pressure of the seat belts are adjusted as a function of the weight class and therefore require the continuous readiness of the weight-sensing system. A failure of the weight-sensing system leads directly to a safety risk for the occupants.

In the case of a method of monitoring the operatability of the weight-sensing system, the weight-sensing system emits a warning message when a threshold value for the force acting upon the force sensor 2, 4, 6, 8 is exceeded, which warning message points to possible damage to the weight-sensing system. The warning message contains a notice for the driver of the vehicle that he should drive to a repair shop in order to check the weight-sensing system. Even in the event of violent shocks which are not necessarily caused by an impact, the weight-sensing system could be damaged. The threshold value for the force acting upon the force sensor 2, 4, 6, 8 should be clearly above the weight of the respective occupant. The shock-caused possible failure of the weight-sensing system above a threshold value for the force acting upon the force sensor 2, 4, 6, 8 is indicated immediately. The occupants' safety is considerably improved by this method.

In addition, in another embodiment, in the event of an impact of the motor vehicle, the warning message is emitted by an impact sensor of the vehicle sensing the impact, which impact sensor may be formed by an acceleration sensor. This additionally increases the safety of the occupants of the vehicle. It is definitely possible that, during an accident, no forces are detected by the weight-sensing system which exceed the threshold value for the force acting upon the force sensor 2, 4, 6, 8, if this force acts, for example, perpendicularly with respect to the sensing direction, and damage to the weight-sensing system has nevertheless taken place. For this reason, in this embodiment, the impact is detected independently of the weight-sensing system, by another system which is not shown. In particular, when the defined threshold value for the force acting upon the force sensor 2, 4, 6, 8 is not reached, in the event of an impact of the vehicle, the warning message can be emitted by the occupant protection system sensing the impact. The impact can also be sensed by other systems, for example, by a system for detecting range of motion.

The warning message generated by the weight-sensing system in the event of a demand, is made available for further usage purposes on a CAN (car area network)—bus 14—an information channel conceived especially for the vehicle operation—, or in fault memories. The CAN bus also contains, for example, information concerning the opening condition of the doors, the usage of seat belts, the weight classification and other diagnostic units.

Among other things, the warning message is displayed in a combination instrument in the vehicle occupant compartment, which is not shown in detail. The warning message is implemented in the form of a text message and/or as a further development of an indicator lamp. If the warning message is filed in a fault memory, the warning information can be read out in a diagnostic unit.

By means of the indicated method, an almost complete checking or monitoring of the weight-sensing system is ensured even when values for internal defect parameters are not exceeded. By means of the display of the fault message for the weight-sensing system, a possible malfunctioning of the occupant protection system is also indicated.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. Method of monitoring the operatability of a weight-sensing system in a vehicle having at least one force sensor,
comprising the steps:
detecting force acting on said at least one sensor; emitting a first warning message when a threshold value for the force acting upon the at least one force sensor is exceeded, wherein said warning message indicates possible damage to the weight-sensing system.

2. Method according to claim 1, wherein,
in the event of an impact of the vehicle, a second warning message independent of said first warning message is emitted by another sensor of the vehicle sensing the impact.

3. Method according to claim 1, wherein,
when the given value of the force acting upon the at least one force sensor (2, 4, 6, 8) in the event of an impact of the vehicle is not reached, another warning message is emitted by an occupant protection system sensing the impact.

4. Method according to claim 1, wherein,
the warning message is displayed in a combination instrument of the vehicle.

5. Method according to claim 1, wherein,
the warning message is at least one of set on a CAN (car area network) bus and filed in a fault memory.

6. Method according to claim 1, wherein said at least one force sensor is a strain gauge force transducer, an inductive sensor or a piezoelectric sensor.

7. A method of monitoring a vehicle weight sensing system comprising the steps:
providing a force sensor arrangement in said vehicle independent of an impact sensor arrangement,
measuring a force applied to said sensor arrangement,
comparing said measured force to a predetermined value,
outputting a warning signal when said measured force exceeds said predetermined value.

8. The method of claim 7, wherein said force system arrangement includes at least one force sensor.

9. Method according to claim 7, wherein,
the warning message is at least one of set on a CAN (car area network) bus and filed in a fault memory.

10. Method according to claim 8, wherein said at least one force sensor is a strain gauge force transducer, an inductive sensor or a piezoelectric sensor.

11. Method according to claim 7, wherein,
the warning message is displayed in a combination instrument of the vehicle.

12. The method according to claim 4, wherein,
said warning message is a text or a signal light.

13. The method according to claim 11, wherein,
said warning message is a text or a signal light.
